(19) United States
(12) Patent Application Publication
(10) Pub. No.: US 2025/0017352 A1
(43) Pub. Date: Jan. 16, 2025

(54) APPARATUS FOR DISPENSING PERFUME

(71) Applicant: EROSE S.R.L., Venezia (IT)

(72) Inventors: Alessandro GALLO, Venezia (IT); Francesca RINALDO, Venezia (IT)

(21) Appl. No.: 18/834,876

(22) PCT Filed: Feb. 15, 2023
(86) PCT No.: PCT/IT2023/050047

§ 371 Date: Jul. 31, 2024

(30) Foreign Application Priority Data
Feb. 16, 2022 (IT) 102022000002894

(51) Int. Cl. A45D 34/02; B65D 83/20; B65D 83/22; B65D 83/38

(52) U.S. Cl. CPC A45D 34/02; B65D 83/205; B65D 83/22; B65D 83/384; A45D 2200/057

(57) ABSTRACT

Disclosed is a perfume dispensing apparatus. The apparatus has a dispensing unit with a bottle adapted to receive the perfume to be dispensed and a manually operable dispenser for dispensing the perfume. An external container is provided with a mouth adapted to allow the insertion of the dispensing unit inside the external container. The connection between the dispensing unit and the external container is adapted to allow the removable-type coupling of the dispensing unit with the external container.

### TECHNICAL FIELD OF THE INVENTION

The present invention relates to the technical field of cosmetics and, specifically, to the field of perfume dispensing systems. More in particular, it relates to a perfume dispensing apparatus.

### DESCRIPTION OF THE PRIOR ART

In the field of dispensing devices of perfumes, such as Eau de Cologne, Eau de Parfum and Eau de Toilette it is known to use containers of various shapes and sizes which adapt to the amount of dispensable perfume, the type of perfume and aesthetic needs.

As known, perfumes are hydroalcoholic solutions consisting of alcohol from 60° to 80° and concentrated fragrance, always contained in glass bottles of various shapes and sizes with closures consisting of sealing caps or pumps and vaporizers seamed or screwed to the mouth of the bottle. Due to the alcoholic nature of perfumes, the amount of perfume used in each bottle never exceeds the value of 300 ml and the containers/bottles thus have limited dimensions which adapt to these volumes.

A need of manufacturers has always been to construct dispensing systems which meet the needs or demands of the consumer while maintaining the correct volumes of dispensable liquid and, at the same time, the desired aesthetic features or shape of the container, ensuring a good handling of the perfume dispensing device.

Therefore, an object of the present invention is to propose a perfume dispensing system which is alternative to the known type of systems.

Another object of the invention is to make a perfume dispensing system which makes its use easier for the user.

A further object of the invention is also to make a perfume dispensing system which reduces the manufacturer's production costs.

Finally, the invention intends to make a perfume dispensing system which reduces the purchase costs borne by the consumer.

### SUMMARY OF THE PRESENT INVENTION

The present invention moves from the general idea of making a perfume dispensing apparatus provided with a replaceable-type dispensing unit.

According to a first aspect thereof, the present invention therefore relates to a perfume dispensing apparatus, in which the apparatus comprises:
a dispensing unit comprising a bottle adapted to receive said perfume to be dispensed and manually-operable dispensing means for dispensing said perfume;
an external container provided with a mouth adapted to allow the insertion of said dispensing unit inside said external container;
means for connecting said dispensing unit to said external container adapted to allow the removable-type coupling of said dispensing unit with respect to said external container.

Advantageously, the dispensing unit can be removed to be replaced with a new dispensing unit.

In the preferred embodiment, the external container comprises an aerosol adapted to receive pressurized products, said aerosol can preferably being compliant with the standards imposed by the European Aerosol Federation (FEA).

Preferably, said connection means comprise an interconnection container adapted to receive and maintain the bottle in a fixed position and means for connecting the interconnection container to the mouth of the external container.

According to a preferred embodiment, said connection means comprise at least one seat for receiving an edge of said mouth.

In a preferred embodiment, said seat is made in an elastically yieldable portion of the interconnection container.

This allows to facilitate assembling the interconnection container to the mouth of the external container, preferably by snapping it inside the external container.

The dispensing means of the dispensing unit comprise a dispensing pump applied to the bottle, preferably a self-priming pump with a non-return system.

According to a preferred embodiment, the connection means further comprise a fastening ring nut adapted to removably connect to the mouth of the external container.

In a preferred embodiment, the fastening ring nut comprises snap fastening means to the mouth of the external container.

Preferably, the ring nut comprises locking means for locking the dispensing unit.

Advantageously, such a ring nut and such an interconnection container ensure the absence of tilting and vertical oscillations of the bottle.

In the preferred embodiment, the perfume is received non-pressurized inside the bottle.

The present invention further relates to a dispensing unit comprising a bottle adapted to receive a perfume to be dispensed and manually-operable dispensing means for dispensing said perfume, in which said dispensing unit is operable in a perfume dispensing apparatus made as described above.

### BRIEF DESCRIPTION OF THE FIGURES

Further advantages, objects and features as well as embodiments of the present invention are defined in the claims and will be clarified hereinafter in the following description which will refer to the accompanying drawing tables. In particular, in the figures:

FIG. 1 shows in axonometric view a perfume dispensing apparatus according to a preferred embodiment of the invention;

FIG. 2 shows the apparatus of FIG. 1 with the cap raised;

FIG. 3 shows a partially exploded view of FIG. 2;

FIG. 4 shows some elements of FIG. 3 isolated from the rest;

FIG. 5 shows a view from above of FIG. 1;

FIG. 6 depicts the sectional view along the line VI°-VI° of FIG. 5;

FIG. 7 shows an enlarged detail of FIG. 6;

FIG. 8 depicts the sectional view along the line VIII°-VIII° of FIG. 5;

FIG. 9 shows an enlarged detail of FIG. 8;

FIG. 10 shows in axonometric view an element of FIG. 3 isolated from the rest;

FIG. 11 shows the element of FIG. 10 according to another point of view;

FIG. 12 depicts an enlarged view of a detail of an element of FIG. 4;

FIG. 13 shows an embodiment variant of the element of FIG. 10.

### DETAILED DESCRIPTION OF PREFERRED EMBODIMENTS OF THE PRESENT INVENTION

Although the present invention is described below with reference to the embodiments depicted in the drawing tables, the forms described and depicted herein are not the only ones which the present invention can assume. The embodiments described below and depicted in the drawing tables clarify some aspects of the present invention, the scope of which is however defined by the claims.

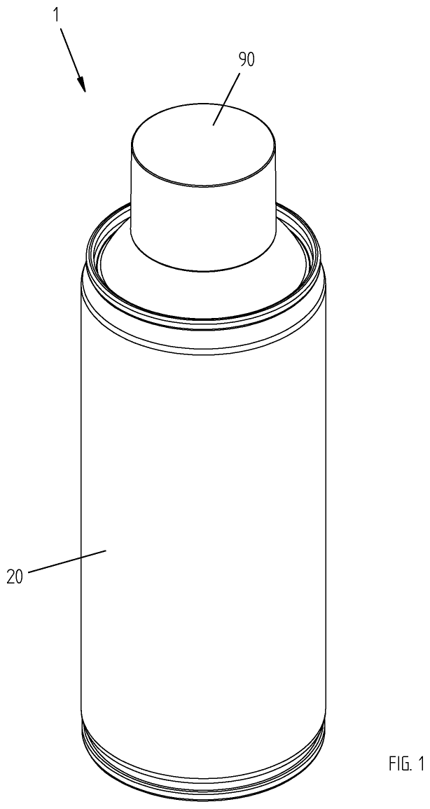

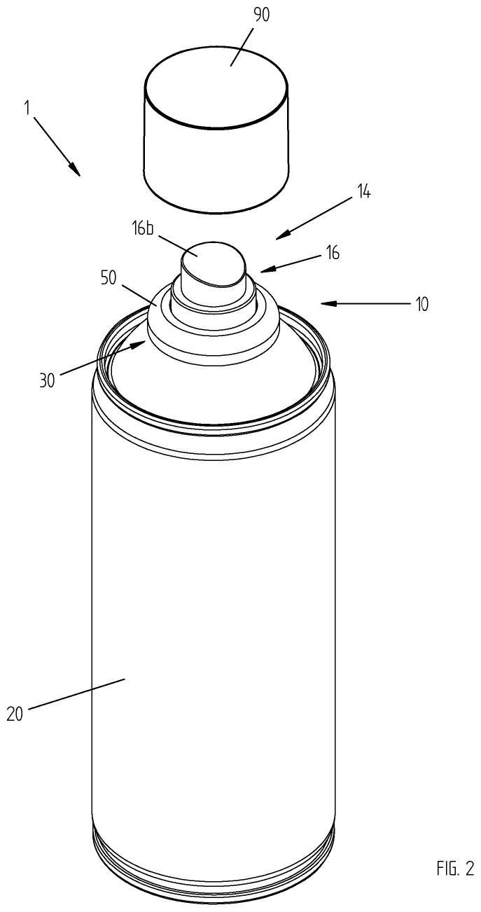

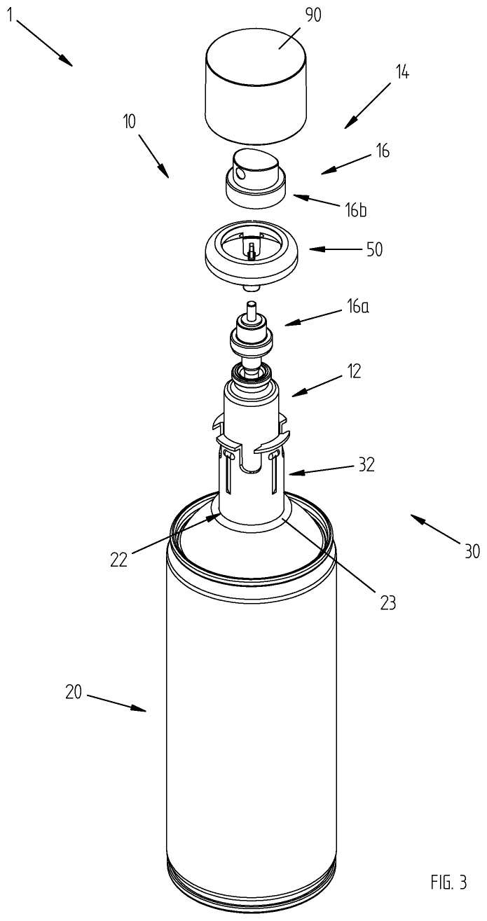

One embodiment of the invention corresponds to the perfume dispensing apparatus depicted in FIG. 1, in which the apparatus, considered as a whole, is identified by the number 1.

The apparatus 1 preferably comprises a dispensing unit 10, an external container 20 and connection means 30 of the dispensing unit 10 to the external container 20.

The dispensing unit 10 preferably comprises a bottle 12 adapted to receive an amount of perfume to be dispensed and manually-operable dispensing means 14 for dispensing the perfume.

The bottle 12 is preferably made of glass, as an ideal material for receiving and storing a perfume. In fact, perfume consists of hydroalcoholic solutions consisting of alcohol from 60° to 80° and concentrated fragrance and the features thereof are maintained longer over time if such a liquid is placed inside a hermetically closed glass container.

The bottle 12 has a preferably elongated form and shaped to receive a standard amount of perfume equal to 125 ml.

Furthermore, the perfume is preferably housed in the bottle 12 in a non-pressurized state, a state particularly adapted for perfumes such as Eau de Cologne, Eau de Toilette and Eau de Parfum.

The dispensing means 14 preferably comprise what is known as a dispensing pump 16 applied to the bottle 12, more preferably a self-priming pump with a non-return system, according to the prior art.

The dispensing pump 16 preferably comprises a first closing part 16a associated with the open upper part 12a of the bottle 12 and a dispensing button 16b operable by the user. An immersed tube 16c extends inside the bottle 12.

The external container 20 is provided with a mouth 22 adapted to allow the insertion of the dispensing unit 10 therein.

The external container 20 comprises an aerosol can commonly used to receive pressurized products.

Preferably, the aerosol can is a can commonly referred to as a spray can. More preferably the aerosol can is a tin-plated iron can, also known as a tinplate can. More generally, the external container can comprise cans which comply with the standards imposed by the EAF, European Aerosol Federation.

As is known, aerosol cans are used to receive pressurized products and allow them to be dispensed in the form of sprays. The pressure of such products is typically between 2, 5 and 15 Bar. In particular, a pressure of 15 Bar refers to aerosol products made with compressed gases (e.g., Nitrogen), while with liquefied gases it does not exceed 7-8 Bar.

To this end, the aerosol cans are provided with a shaped mouth 22 on which special dispensing devices are applied which hermetically close said mouth and allow to dispense the product in the form of a spray after actuation of a special dispensing button.

According to an aspect of the present invention, the aerosol can 20 is not used to directly receive the pressurized perfume according to the standards, but the use thereof is envisaged for receiving the dispensing unit 10 described above.

Preferably, the aforesaid connection means 30 are associated with the aerosol can 20 to allow the removable connection of the dispensing unit 10 to the aerosol can 20 itself.

Therefore, an advantage of the present invention is that the dispensing unit 10 constitutes a spare unit because the dispensing unit 10 can be replaced with a new unit when the perfume contained therein is finished or can be replaced with a unit containing a different fragrance, as described in more detail below.

The connection means 30 preferably comprise an interconnection container 32 adapted to receive and maintain the bottle 12 in a fixed position and means 34 for connecting the interconnection container 32 to the mouth 22 of the aerosol can 20.

The connection means 34 preferably comprise at least one receiving seat 36 of an edge 23 of said mouth 22. The edge 23 is preferably defined by a toroidal portion and is preferably compliant with the aforesaid regulations regarding the construction of aerosol cans.

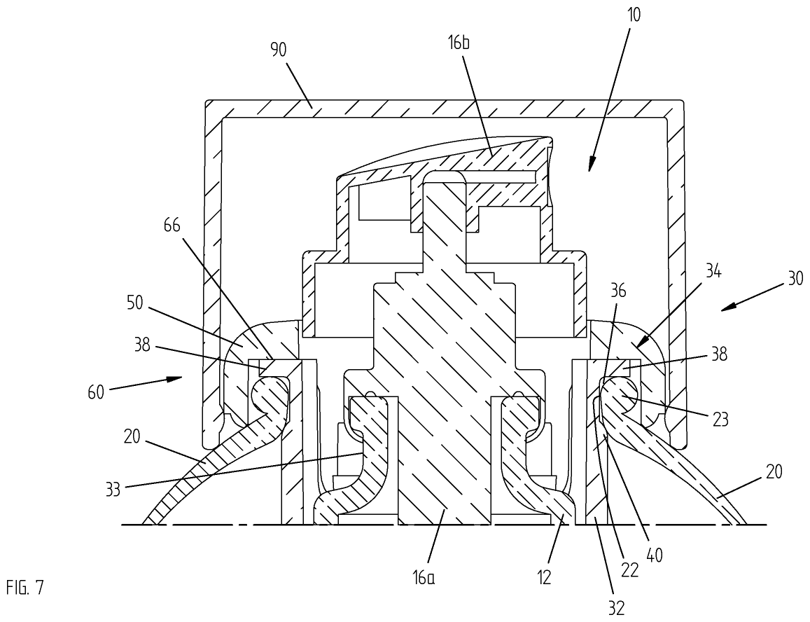

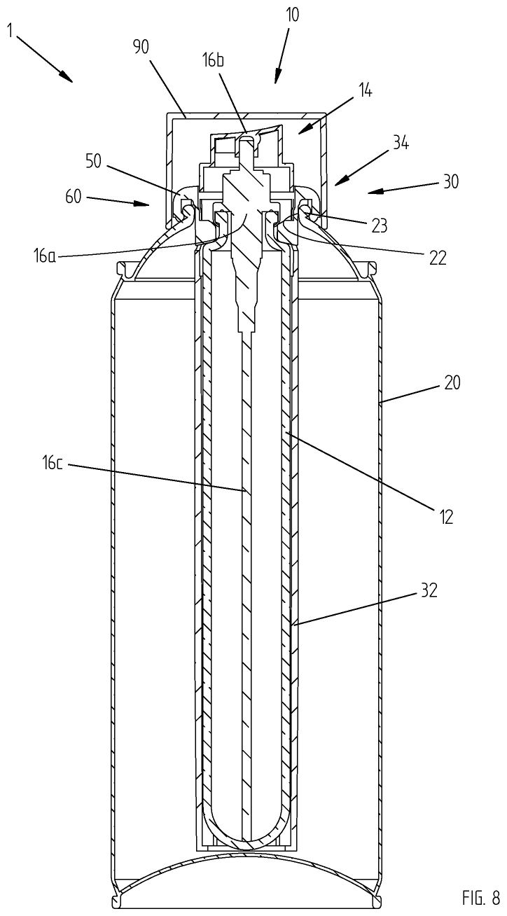

Said seat 36 is preferably defined by an upper projecting surface 38 which abuts above the edge 23 of said mouth 22 and a projecting rib 40 which abuts below the edge 23 of said mouth 22, as shown in FIG. 7. The edge 23 is advantageously snap-received in said seat 36.

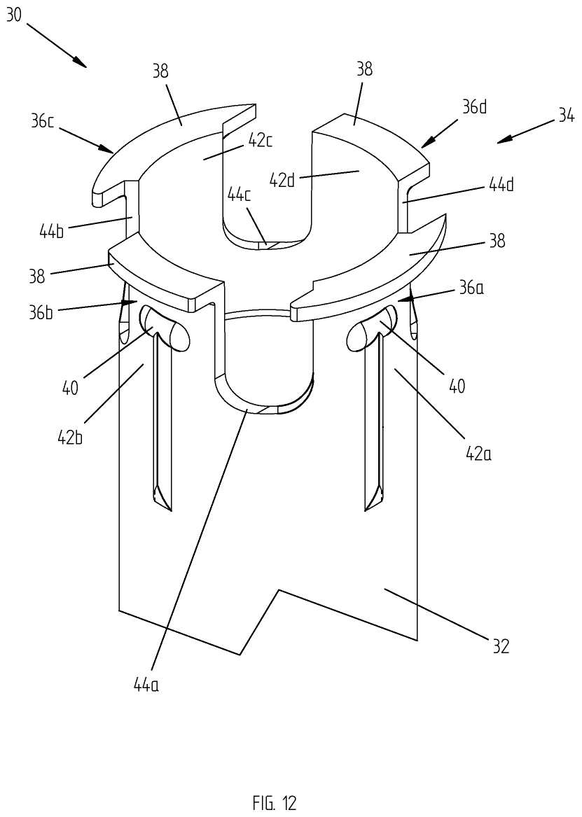

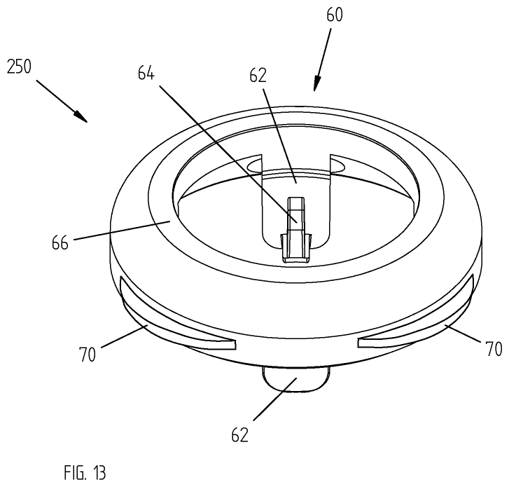

Said seat 36 is preferably divided into 4 seats 36a, 36b, 36c, 36, as shown in FIG. 12, which extend circumferentially in the upper part of the interconnection container 32. In possible embodiment variants, a different number of seats can be provided.

More preferably, such seats 36a, 36b, 36c, 36d are made in corresponding elastically yieldable portions 42a, 42b 42c, 42d of the interconnection container 32. Such elastically yieldable portions 42a, 42b 4c, 42d are obtained through as many openings 44a, 44b 44c, 44d made in the interconnection container 32 in an upper end zone thereof.

Such an elasticity feature facilitates the assembly of the interconnection container 32 to the mouth 22 of the aerosol can 20 by snap-inserting it inside the aerosol can 20.

The interconnection container 32 preferably receives the entire length of the bottle 12 of the dispensing unit 10.

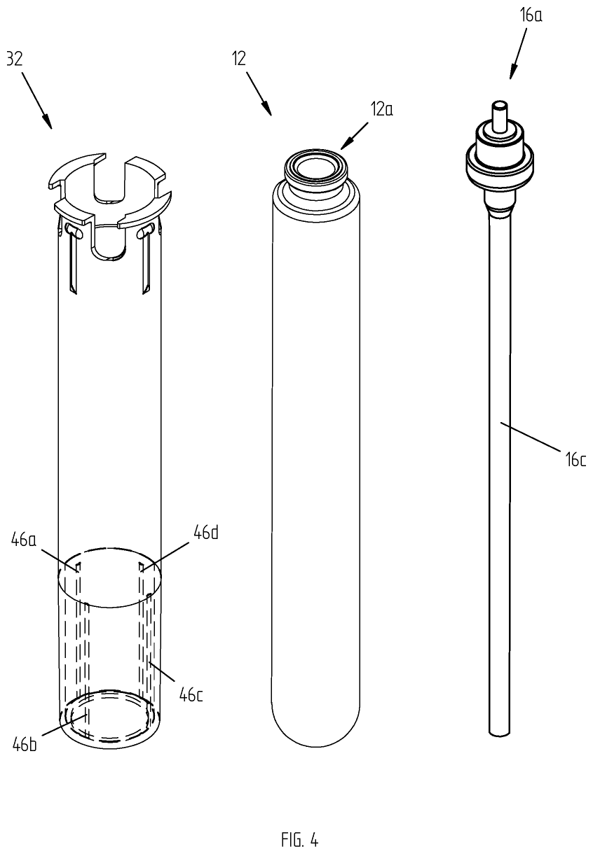

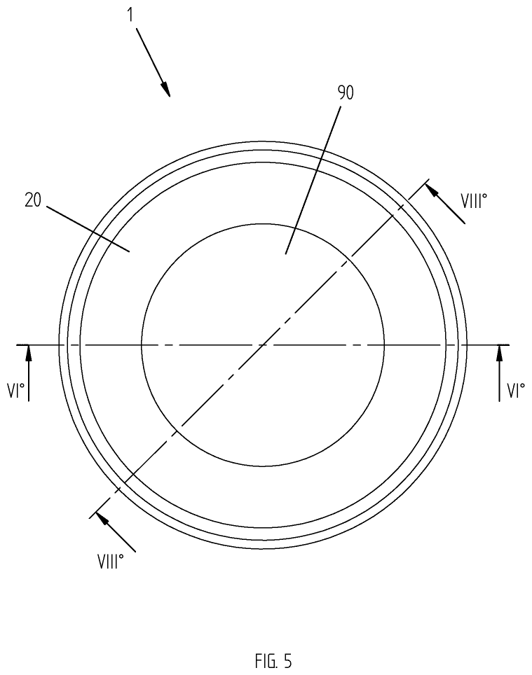

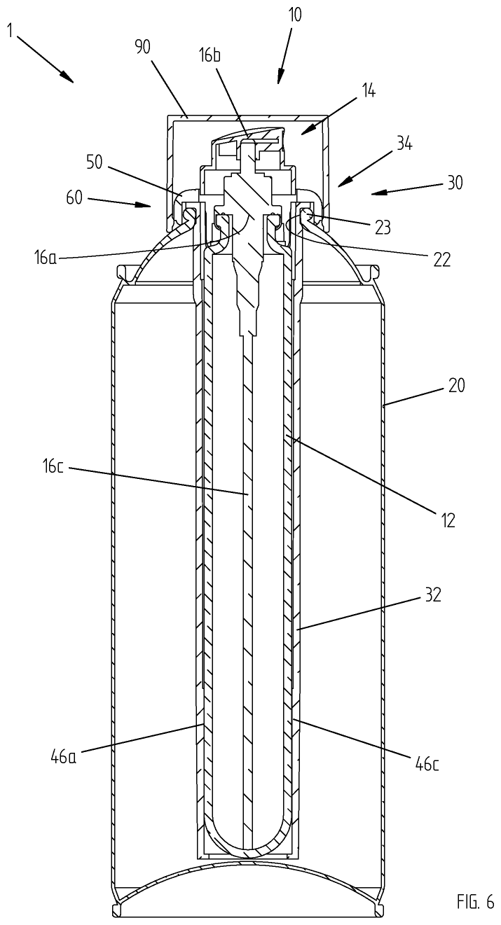

Preferably, the interconnection container 32 further comprises 4 longitudinal reliefs 46a, 46b 46c, 46d, visible in FIG. 4, projecting inside and at the bottom of the container 32 which mechanically lock the bottle 12 in the lower end part by interference.

In particular, such longitudinal reliefs 46a, 46b 46c, 46d define a vertical compensation system capable of absorbing the dimensional tolerances of the bottle 12, in particular when the bottle is made of glass.

The connection means 30 preferably further comprise a fastening ring nut 50 adapted to removably connect to the mouth 22 of the aerosol can 20.

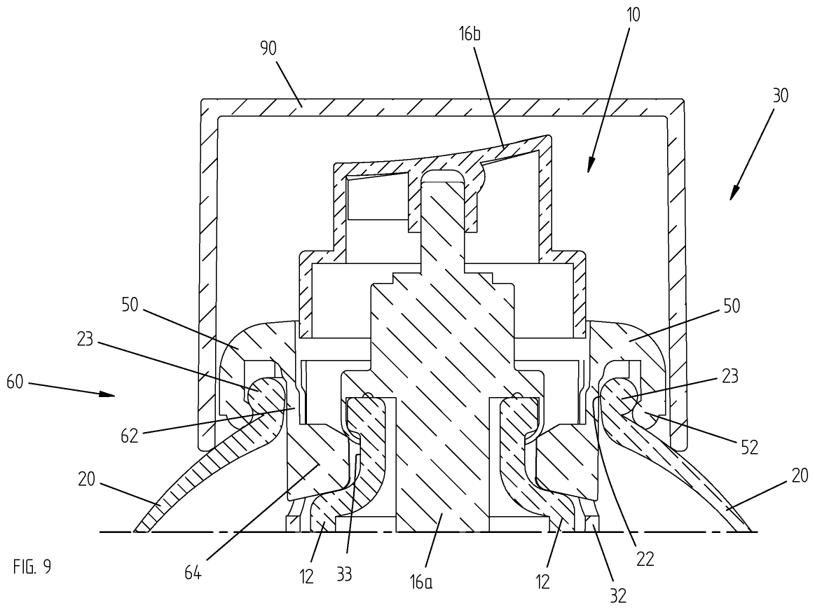

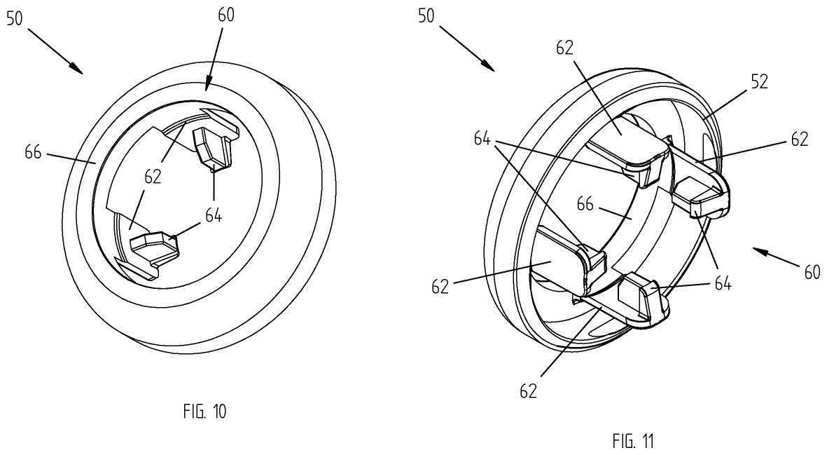

To this end, the fastening ring nut 50 comprises snap fastening means to the mouth 22 of the aerosol can 20. Such a snap connection is preferably obtained from an undercut edge 52 of the fastening ring nut 50 which engages the corresponding edge 23 of the mouth 22 of the aerosol can 20, as visible in FIG. 9.

In possible embodiment variants of the invention, the connection of the ring nut to the aerosol can may be obtained in a different and equivalent manner, for example by screwing or with a bayonet connection system.

The ring nut 50 preferably comprises locking means 60 for locking the dispensing unit 10.

The locking means 60 preferably comprise two or more elastic locking tabs 62 cooperating with the dispensing unit 10. In the illustrated and described embodiment, the elastic tabs 62 comprise respective radially recessed surfaces 64 which insert in a rib 33 of the bottle 12, as illustrated in FIG. 9.

According to the preferred illustrated and described embodiment, there are four elastic tabs 62, as shown in particular in FIG. 11. In possible embodiment variants, a different number of tabs can be provided.

The locking means 60 preferably further comprise a stop surface 66 adapted to abut the upper projecting surface 38 of the container 32, visible in particular in FIG. 7.

When the ring nut 50 is connected to the aerosol can 20, the dispensing unit 10 is kept in a fixed position allowing its correct use. Conversely, when the ring nut 50 is disconnected from the aerosol can 20, the dispensing unit 10 can be easily removed to be replaced.

As described, the ring nut 50 and the interconnection container 32 ensure the fastening of the dispensing unit 10 to the aerosol can 20 and at the same time ensure the absence of tilting and vertical oscillations of the bottle 12.

In an alternative preferred embodiment, to facilitate the grip of the ring nut 250 and the manipulation thereof in the connection/disconnection steps with respect to the aerosol can 20, the ring nut 250 can preferably comprise protruding gripping tabs 70, as shown in a possible embodiment variant of the ring nut 250 in FIG. 13.

Lastly, the dispensing apparatus 1 preferably comprises a cap 90 placed to protect the dispensing button 16b. The cap 90 is preferably snap-connected to the ring nut 50.

The dispensing apparatus 1 according to the invention allows to obtain a solution inspired by the use of an aerosol can as an external casing easily handled by the user, while dispensing a non-pressurized perfume, such as Eau de Cologne, Eau de Toilette.

The proposed solution further allows to keep the outer casing consisting of the aerosol can and replace the dispensing unit.

Advantageously, the new dispensing unit can replace the finished dispensing unit or it can contain a different fragrance, thus making the use of the aerosol can more flexible to dispense different fragrances chosen by the user from time to time.

The aerosol can be advantageously shaped according to the aesthetic choices of the manufacturer, with reference to the shape and/or the decorations and/or the writings such as brands and logos. On the other hand, the dispensing unit constituting the spare part can comprise standard glass bottles which can be made at a reduced cost with respect to traditional glass bottles.

This entails a reduction in production costs for the manufacturer, on the one hand, and a reduction in the purchase price for the user who can, from time to time, purchase a spare dispensing unit at reduced costs.

Therefore, from what is described, it can be seen that the dispensing apparatus of the invention allows to achieve the preset objects and, in particular, to make a perfume dispensing system which is alternative to the systems of known type.

While the present invention has been described with reference to the particular embodiments depicted in the figures, it should be noted that the present invention is not limited merely to these particular embodiments; on the contrary, further variants of the described embodiments fall within the scope of the present invention, which scope is defined by the claims.

1. An apparatus for dispensing a perfume, comprising:
a dispensing unit comprising a bottle suitable for receiving said perfume to be dispensed and a manually operable dispensing means for dispensing said perfume;
an outer container provided with a mouth suitable to allow the insertion of said dispensing unit inside said outer container;
a connecting means of said dispensing unit to said outer container suitable to allow the removable coupling of said dispensing unit to said outer container.

2. The apparatus according to claim 1, wherein said outer container further comprises an aerosol container suitable for receiving products under pressure, with said aerosol container preferably complying with the European Aerosol Federation standards.

3. The apparatus according to claim 1, wherein said connecting means comprises:
an interconnection container suitable for receiving and maintaining in a fixed position said bottle; and
a connection means of said interconnection container to said mouth of said outer container.

4. The apparatus according to claim 3, wherein said connection means comprises at least one seat for receiving an edge of said mouth.

5. The apparatus according to claim 4, wherein said seat is realized in an elastically yielding portion of said interconnection container.

6. The apparatus according claim 1, wherein said dispensing means of said dispensing unit comprises a dispensing pump applied to said bottle, with said dispensing pump preferably being a self-priming pump with a non-return system.

7. The apparatus according to claim 3, wherein said connecting means further comprises a fastening ring suitable to be connected in a removable way to said mouth of said outer container.

8. The apparatus according to claim 7, wherein said fastening ring comprises a snap-fitting means for a snap-fitting connection to said mouth opening of said outer container.

9. The apparatus according to claim 7, wherein said ring comprises a locking means for locking said dispensing unit.

10. The apparatus according to claim 9, wherein said locking means comprises two or more elastic tabs cooperating with said bottle and/or cooperating with said dispensing means of said dispensing unit.

11. The apparatus according to claim 1, wherein said perfume is received non-pressurized within said bottle.

12. A dispensing unit comprising a bottle suitable for receiving a perfume to be dispensed and a manually operable dispensing means for dispensing said perfume, wherein said dispensing unit corresponds to said dispensing unit of an apparatus for dispensing a perfume according to claim 1.
